(19) United States
(12) Patent Application Publication
(10) Pub. No.: US 2026/0227957 A1
(43) Pub. Date: Aug. 6, 2026

(54) FLEXMAX FOR FLEXIBLE SOFTMAX FUNCTIONS

(71) Applicant: QUALCOMM Incorporated, San Diego, CA (US)

(72) Inventors: Jian SHEN, San Diego, CA (US); Jamie Menjay LIN, San Diego, CA (US)

(21) Appl. No.: 19/046,386

(22) Filed: Feb. 5, 2025

(51) Int. Cl. G06F 7/556; G06F 7/483

(52) U.S. Cl. CPC G06F 7/556; G06F 7/483

(57) ABSTRACT

A processor-implemented method for applying a flexible softmax function in machine learning models includes receiving a machine learning model including one or more configurable softmax functions. A base parameter is selected for the one or more configurable softmax functions. During training of the machine learning model, an exponential function of the one or more configurable softmax functions is configured based on the base parameter.

### FIELD OF THE DISCLOSURE

Aspects of the present disclosure generally relate to machine learning and more particularly to flexible activation functions for machine learning models.

### BACKGROUND

Artificial neural networks may comprise interconnected groups of artificial neurons (e.g., neuron models). The artificial neural network (ANN) may be a computational device or be represented as a method to be performed by a computational device. Various ANN model structures are available for consideration. Convolutional neural networks (CNNs) are a type of feed-forward ANN. Convolutional neural networks may include collections of neurons that each have a receptive field and that collectively tile an input space.

A transformer ANN structure makes use of attention mechanisms that may enable the model to process input sequences in a parallel and efficient manner. An attention mechanism allows the model to focus on different parts of the input sequence at different times. A transformer ANN structure may be of particular use for tasks that involve sequence modeling, such as text generation by a large language model (LLM).

One key arithmetic function in various machine learning models is the softmax function. Softmax functions are employed in attention modules, transformers, diffusion models, LLMs, large vision models (LVMs), as well as in generative artificial intelligence models for image/video generation and editing. The softmax function may be used as an activation function of a machine learning model to normalize output of a neural network to a probability distribution over a set of predicted output classes. Computation of the softmax involves the evaluation of an exponential function over the real (R) base of Euler's number (e=2.71828 . . . ) series, which may be challenging to compute. Moreover, numerical precision for evaluation may be limited in fixed point arithmetic, particularly on resource limited mobile devices.

### SUMMARY

Various aspects of the present disclosure are directed to an apparatus. The apparatus has a memory and one or more processors coupled to the memory. The processor(s) is configured to receive a machine learning model including one or more configurable softmax functions. The processor(s) is also configured to select a base parameter for the one or more configurable softmax functions. The processor(s) is further configured to configure, during training of the machine learning model, an exponential function of the one or more configurable softmax functions based on the base parameter.

In some aspects of the present disclosure, a processor-implemented method includes receiving a machine learning model including one or more configurable softmax functions. The processor-implemented method also includes selecting a base parameter for the one or more configurable softmax functions. The processor-implemented method further includes configuring, during training of the machine learning model, an exponential function of the one or more configurable softmax functions based on the base parameter.

Various aspects of the present disclosure are directed to an apparatus. The apparatus includes means for receiving a machine learning model including one or more configurable softmax functions. The apparatus also includes means for selecting a base parameter for the one or more configurable softmax functions. The apparatus further includes means for configuring, during training of the machine learning model, an exponential function of the one or more configurable softmax functions based on the base parameter.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIG. 2 is an illustrative block diagram of an example machine learning (ML) model represented by an artificial neural network (ANN), in accordance with aspects of the present disclosure.

FIG. 3 is a block diagram illustrating an example transformer encoder block of a large language model (LLM), in accordance with various aspects of the present disclosure.

FIG. 4 is a block diagram illustrating an exemplary software architecture that may modularize artificial intelligence (AI) functions, in accordance with aspects of the present disclosure.

FIGS. 5 and 6 are diagrams illustrating components of various number formats, in accordance with various aspects of the present disclosure.

FIG. 7 is a process flow diagram illustrating an exponential function with a flexible base, in accordance with various aspects of the present disclosure.

FIG. 8 is a flow diagram illustrating a processor-implemented method for configuring machine learning models for implementing a flexible softmax function, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The softmax function is an arithmetic function that is frequently used in various machine learning (ML) models and tasks, including attention modules, transformers, diffusion models, large language models (LLMs), large vision models (LVMs), as well as generative artificial intelligence (AI) models for image/video generation and editing.

The conventional softmax function may be expressed as:

$${σ ( \vec{z} )}_{i} = \frac{{e}^{{z}_{i}}}{{\sum }_{j = 1}^{K} {e}^{{z}_{j}}} .$$

The computation for softmax in such ML models, however, involves the evaluation of an exponential function over the real (R) base of Euler's number (e=2.71828 . . . ) mathematically defined as

$$e = 1 + \frac{1}{1} + \frac{1}{2} + \frac{1}{1 \times 2 \times 3} + \frac{1}{1 \times 2 \times 3 \times 4} + … + \frac{1}{n !} .$$

In practice, use of Euler's number e involves computation complexity and overhead in evaluation because Euler's number may have infinite sub-radix residual components to fully or sufficiently represent. As such, it may be challenging to achieve numerical precision for evaluation, especially with fixed point arithmetic on resource limited devices.

The softmax function may enforce selectivity among input tensor elements through the evaluation of the exponential function, accumulation, and division (normalization). One issue, however, with the conventional softmax function is a lack of selectivity control. That is, there is no hyperparameter for controlling the softmax function. A hyperparameter is a variable that can be set to define a configurable part of a model's learning process.

Moreover, because the conventional softmax function involves evaluation with the exponential function, which has a super-linear function growth rate, the dynamic range of the ML models may be reduced. The dynamic range may refer to a measurement between the maximum values and the minimum values that may be represented in the ML model. For instance, for signed 8-bit integer (INT8) fixed point arithmetic, the dynamic range may be 256 (−128≤d≤128). Thus, when employing the conventional softmax function in an ML model, the size of the input values that the ML model can accommodate may be more limited.

Accordingly, to address these and other challenges, aspects of the present disclosure are directed to implementing a flexible softmax function.

Particular aspects of the subject matter described in this disclosure can be implemented to realize one or more of the following potential advantages. In some examples, the described techniques (e.g., selecting a base parameter for the one or more configurable softmax function and/or configuring, during training of the machine learning model, an exponential function of the one or more configurable softmax functions based on the base parameter) may increase selectivity, dynamic range, and model precision in fixed point arithmetic relative to the conventional softmax function. Furthermore, the described techniques may increase numerical stability of ML model learning and inference.

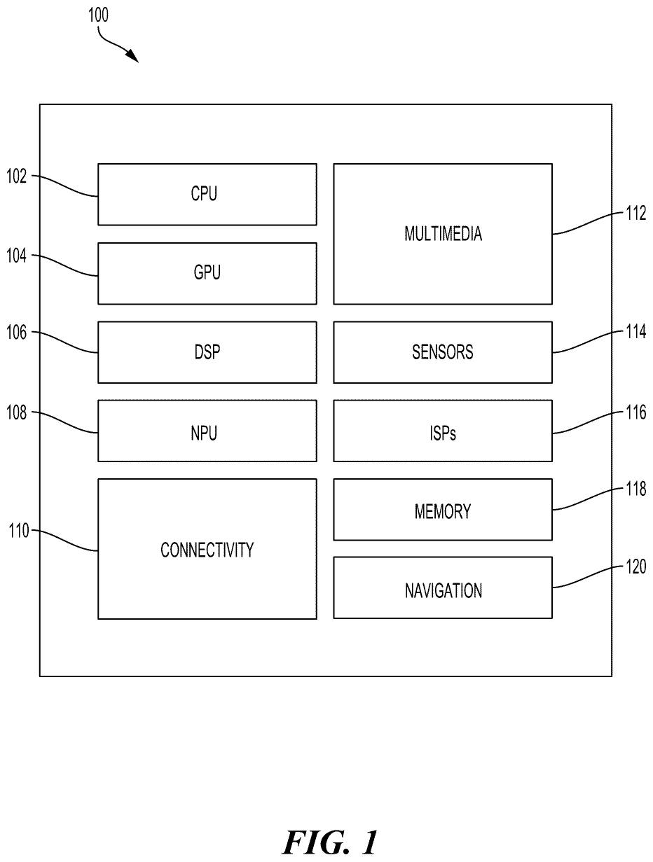

FIG. 1 illustrates an example implementation of a system-on-a-chip (SOC) 100, which may include a central processing unit (CPU) 102 or a multi-core CPU configured for applying flexible softmax functions. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM, RISC-V (RISC-five), or any reduced instruction set computing (RISC) architecture. In aspects of the present disclosure, the instructions loaded into the general-purpose processor 102 may include code to receive a machine learning model including one or more configurable softmax functions. The instructions loaded into the general-purpose processor 102 may also include code to select a base parameter for the one or more configurable softmax functions. The instructions loaded into the general-purpose processor 102 may further include code to configure, during training of the machine learning model, an exponential function of the one or more configurable softmax functions based on the base parameter.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

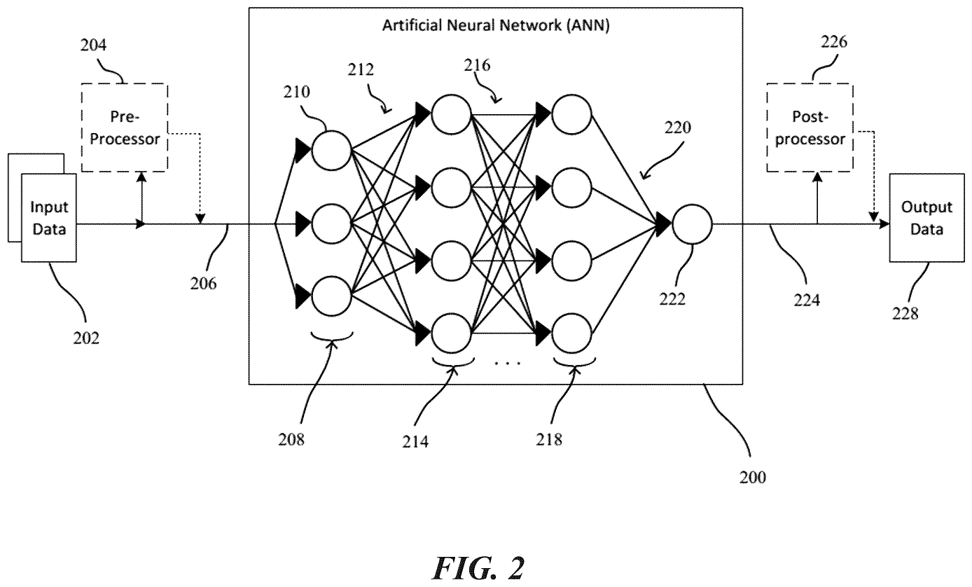

FIG. 2 is an illustrative block diagram of an example machine learning (ML) model represented by an artificial neural network (ANN) 200. The ANN 200 may receive input data 206 which may include one or more bits of data 202, pre-processed data output from pre-processor 204 (optional), or some combination thereof. Here, data 202 may include training data, verification data, application-related data, or the like, based, for example, on the stage of deployment of the ANN 200. A pre-processor 204 may be included within the ANN 200 in some other implementations. The pre-processor 204 may, for example, process all or a portion of the data 202, which may result in some of the data 202 being changed, replaced, deleted, etc. In some implementations, the pre-processor 204 may add additional data to the data 202.

The ANN 200 includes at least one first layer 208 of artificial neurons 210 to process input data 206 and provide resulting first layer data via connections or “edges” such as the edges 212 to at least a portion of at least one second layer 214. The second layer 214 processes data received via the edges 212 and provides second layer output data via the edges 216 to at least a portion of at least one third layer 218. The third layer 218 processes data received via the edges 216 and provides third layer output data via the edges 220 to at least a portion of a final layer 222 including one or more neurons to provide output data 224. All or part of the output data 224 may be further processed in some manner by an optional post-processor 226. Thus, in certain examples, the ANN 200 may provide output data 228 that is based on output data 224, post-processed data output from the post-processor 226, or some combination thereof.

The post-processor 226 may be included within the ANN 200 in some other implementations. The post-processor 226 may, for example, process all or a portion of the output data 224 which may result in the output data 228 being different, at least in part, to the output data 224, as result of data being changed, replaced, deleted, etc. In some implementations, the post-processor 226 may be configured to add additional data to the output data 224. In this example, the second layer 214 and third layer 218 represent intermediate or hidden layers arranged in a hierarchical or other like structure. Although not explicitly shown, there may be one or more further intermediate layers between the second layer 214 and the third layer 218.

The structure and training of artificial neurons 210 in the various layers may be tailored to specific requirements of an application. Within a given layer such as the first layer 208, second layer 214, or third layer 218 of the ANN 200, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of the ANN 200. The weights and biases of the ANN 200 may be adjusted during a training process or during operation of the ANN 200. The weights of the various artificial neurons may control a strength of connections between layers or artificial neurons, while the biases may control a direction of connections between the layers or artificial neurons. An activation function may select or determine whether an artificial neuron transmits its output to the next layer or not in response to its received data.

Different activation functions may model different types of non-linear relationships. By introducing non-linearity into an ML model, an activation function allows the configuration for the ML model to change in response to identifying or detecting complex patterns and relationships in the input data 206. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as the ANN 200, may be conducted using training data. Training data may include one or more datasets the ANN 200 may use to identify patterns or relationships. Training data may represent various types of information, including written, visual, audio, environmental context, operational properties, etc. During training, the parameters (such as the weights and biases) of artificial neurons 210 may be changed, such as to minimize or otherwise reduce a loss function or a cost function. A training process may repeat multiple times to fine-tune the ANN 200 with each iteration.

Various ANN model structures are available for consideration. For example, in a feed-forward ANN structure, each artificial neuron 210 in layer 214 receives information from the previous layer (such as, one or more artificial neurons 210 in layer 208) and produces information for the next layer (such as, one or more artificial neurons 210 in layer 218). In a convolutional ANN structure, some layers may be organized into filters that extract features from data, such as the training data or the input data. In a recurrent ANN structure, some layers may have connections that allow for processing of data across time, such as for processing information having a temporal structure, such as time series data forecasting.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute weighted sums of input features based on a similarity between different elements of the input sequence. A transformer ANN structure may include a series of feed-forward ANN layers whose configurations may change in response to identifying non-linear relationships between the input and output sequences, which may also be referred to as a process of “learning” by the ANN layers. The output of a transformer ANN structure may be obtained by applying a linear transformation to the output of a final attention layer. A transformer ANN structure may be of particular use for tasks that involve sequence modeling, or other like processing, such as text generation. A large language model may be a particularly useful implementation of a transformer ANN structure.

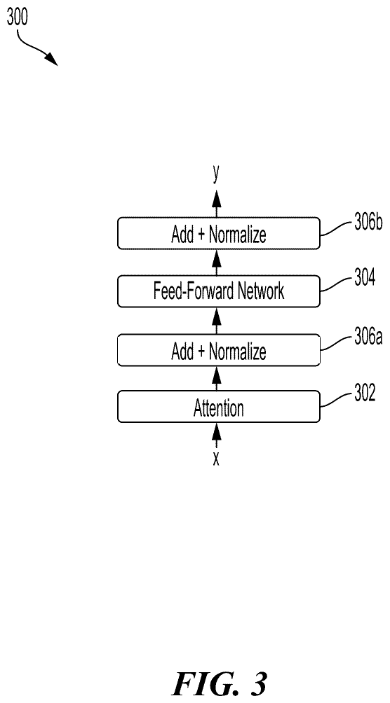

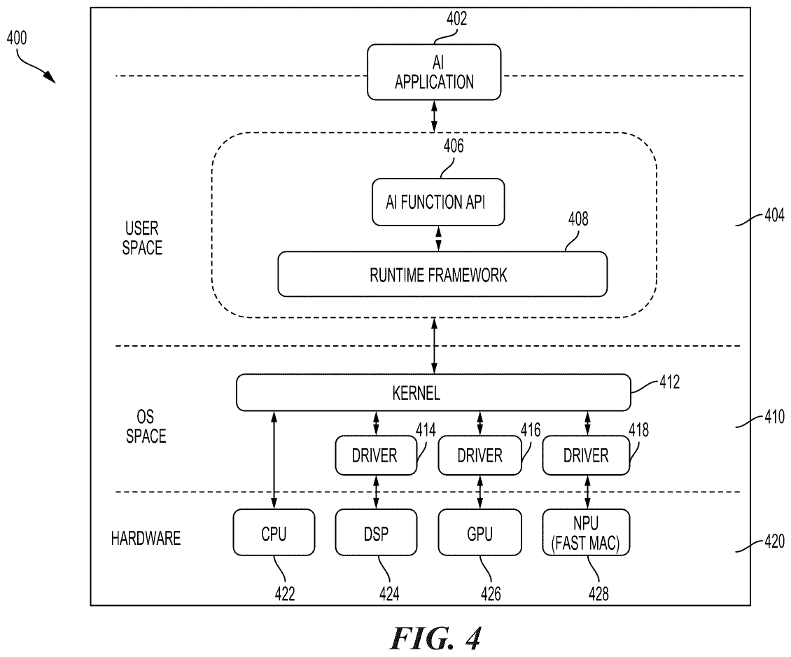

FIG. 3 is a block diagram illustrating an example transformer encoder block 300 of an LLM, in accordance with various aspects of the present disclosure. As shown in FIG. 4, the example transformer encoder block 300 includes alternating layers of attention blocks 302 and feed-forward network (FFN) blocks 304. Normalization blocks 306 (e.g., 306a, 306b) may be applied after every block (e.g., 302, 304) of the example transformer encoder block 300.

In operation, the attention block 302 may receive input tokens along with a positional embedding and may generate a set of attention scores. The attention scores may be provided to the normalization layer (e.g., 306a) to perform a normalization process. For instance, the normalization layer (e.g., 306a) may apply a softmax function (e.g., flexible softmax functions) to generate a set of normalized attention scores that may be transformed into probabilities to generate an inference with respect to the input tokens.

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) (which may be similar to SOC 100 of FIG. 1) to support flexible softmax functions for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

The run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

As described, aspects of the present disclosure are directed to a applying a flexible softmax function for machine learning models. In various aspects, the flexible softmax function may be defined with an exponential base as a configurable hyperparameter.

The flexible softmax function may include applying a softmax with a configurable base that is greater than 1, which may be referred to as “flexmax.” In some aspects, the base may be configured as Euler's number (e.g., e=2.71828). For instance, an exponential function of a base of two has a smaller growth rate than a base of four, while both bases offer unique efficiency in evaluation and approximation, especially in fixed point arithmetic. Flexmax allows configurability in feature selectivity, unlike the conventional softmax. Feature selectivity may refer to the process of selecting relevant variables (e.g., hyperparameters) for a machine learning model during training of the machine learning model, for example. That is, the flexible softmax function may offer a base hyperparameter. The flexible softmax function may be configured based on the selected base hyperparameter.

In some aspects, a flexible softmax function may apply a softmax with a configurable base that is less than one, which may be referred to as “flexmin.” Flexmin may use an exponential base of <1, and may offer a sub-linear growth rate. Flexmin may be the opposite of flexmax with regards to preservation of features of minimum vs. maximum.

In accordance with aspects of the present disclosure, the flexible softmax function may adapt exponentials where the base is a power of two (e.g., ½, 2, 4, 8, 16, 32, etc.). If the exponential has an exponent that is in an integer number format, then the exponential may be implemented by performing a shift operation. For instance, the exponential may be implemented with a left shift operation when the base is greater than one or a right shift operation when the base is less than one.

If the exponential has a fixed point exponent, then the exponent may be split into an integer part and a fractional part, according to a position of the radix point. As an example, an unsigned 16-bit fixed point number U(10,6) has a 10-bit integer (I), a six-bit fractional (F), and two fields I and F. For the integer part, the exponential becomes a left shift operation when the base is greater than one or a right shift operation when the base is less than one. The fractional part may be implemented with a lookup table. Notably, the lookup table may be a small table because the field F is a subset of the overall bitwidth of the fixed point exponent. Then, the integer part may be multiplied by the fractional part to implement the exponential function that is a power of two (e.g., ½, 2, 4, 8, 16) as given by B^{I.F}=B^{I}×B^{F}, where B is the base, I is the integer part, and F is the fractional part.

If the exponential has an exponent that is a floating point number (e.g., FP64, FP32, FP16, FP8), then the exponent may be converted to a fixed point format. The integer part of the fixed point format may be represented as I=2Exp, and the fractional part may be represented by the mantissa of the floating point number. Then, for the integer part, the exponential becomes a left shift operation when the base is greater than one or a right shift operation when the base is less than one. The fractional part may be implemented with a lookup table. Then, the integer part may be multiplied by the fractional part to implement the exponential function that is a power of two (e.g., ½, 2, 4, 8, 16) as given by B^{I.F}=B^{I}×B^{F}. In some aspects, the determination of the integer part and the fractional part may be executed concurrently.

In some aspects, the machine learning model may have a mix of flows in which some layers may use conventional softmax, and other layers may use flexmax. When processing the kernel, hardware (e.g., NPU 108 of FIG. 1) may determine which softmax to employ.

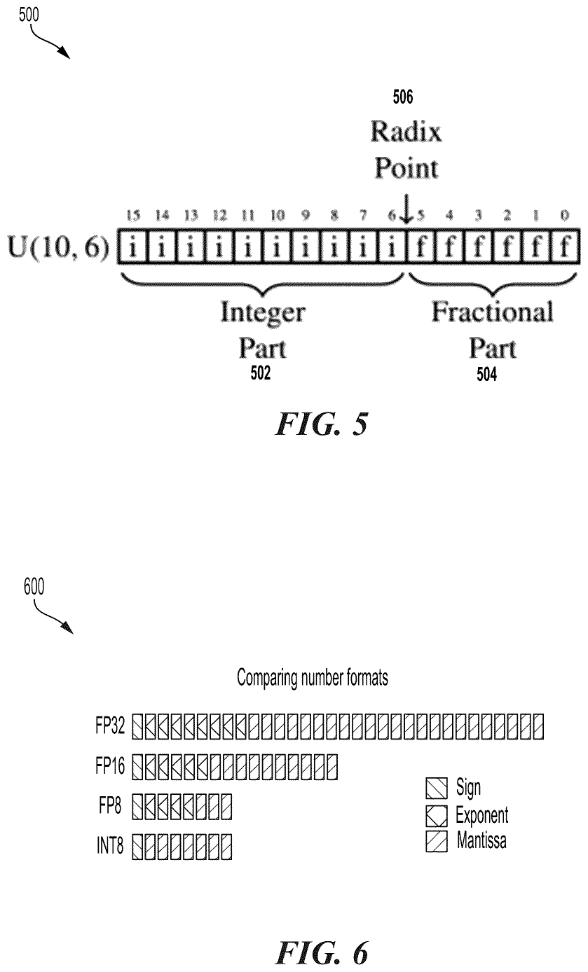

FIGS. 5 and 6 are diagrams illustrating components of various number formats, in accordance with various aspects of the present disclosure. Referring to FIG. 5, an example fixed point number format 500 is shown. The example fixed point number format 500 includes a set of bits that is divided into an integer part 502 and a fractional part 504 according to a radix point 506 (e.g., a decimal point or binary point). The example fixed point number format 500 includes 16 bits with 10 bits in the integer part 502 and 6 bits in the fractional part. However, the number of bits in the format and parts therein are merely examples for ease of understanding and not limitation. The example fixed point number format 500 may represent a number in various number systems including but not limited to decimal or binary, for instance.

FIG. 6 is a diagram 600 illustrating example floating point formats and an example integer format, in accordance with various aspects of the present disclosure. An eight-bit integer (INT8) format has eight bits including a sign bit, and a set of mantissa bits.

FIG. 6 also shows an eight-bit floating point format (FP8), a 16-bit floating point format (FP16), and a 32-bit floating-point format (FP32). Each of the floating point formats may include a sign bit, as well as a set of exponent bits and a set of mantissa bits. The floating point formats and integer format and the number of bits in the respective parts (e.g., mantissa or exponent) are examples and not limiting.

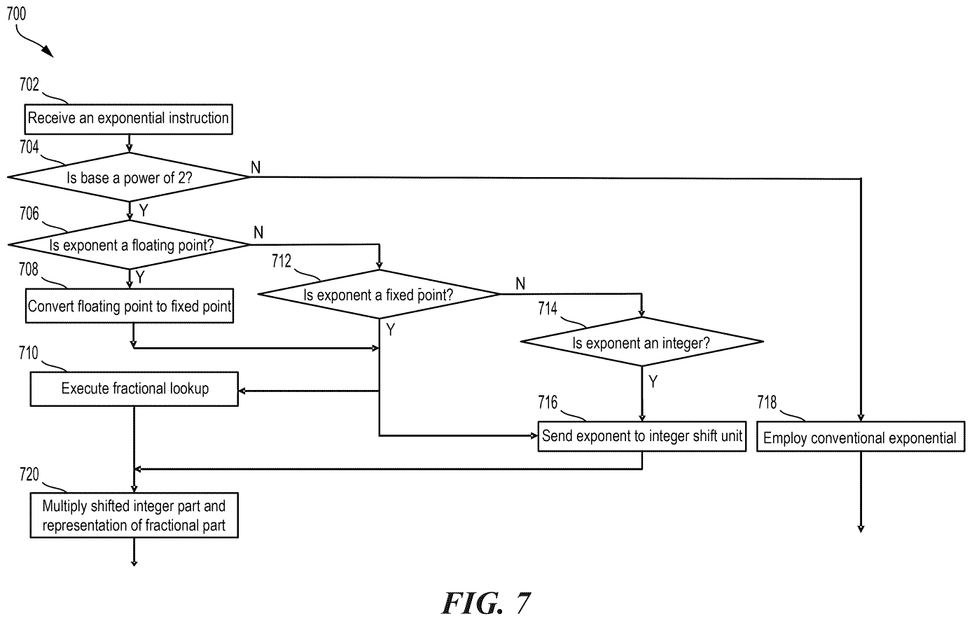

FIG. 7 is a process flow diagram illustrating an exponential function with a flexible base, in accordance with various aspects of the present disclosure. Referring to FIG. 7, at block 702, the process 700 may receive an exponential instruction. The exponential instruction may for instance comprise a flexmin instruction or a flexmax instruction, for example. In various aspects, the exponential instruction may be implemented in machine learning (ML) models and tasks, including attention modules, transformers, diffusion models, large language models (LLMs), large vision models (LVMs), as well as generative artificial intelligence (AI) models for image/video generation and editing.

At block 704, the process 700 may determine if the exponential instruction includes a base of the power of two. If the exponential instruction does not include a base of the power of two, then the process 700 proceeds to block 718 and may employ the conventional exponential.

If, on the other hand, the exponential instruction has a base of the power of two, at block 706, the process 700 may determine if the number format of the exponent is a floating point. If the exponent does not have a floating point format, at block 712, the process 700 may evaluate whether the number format of the exponent is fixed point. If the number format of the exponent is not fixed point, then at block 714, the process 700 may next determine whether the number format of the exponent is an integer. If the number format of the exponent is an integer, at block 716, the process 700 may send the exponent to an integer shift unit. The integer shift unit may execute a shift operation based on the value of the integer. That is, the integer shift unit may execute a left shift operation when x>1 or a right shift operation when x<1.

If, at block 712, the number format of the exponent is determined to be fixed point, the fixed point may be split into two parts, the integer part and the fractional part. The integer part may be sent to the integer shift unit (at block 716). The integer shift unit may execute a shift operation based on the value of the integer part of the fixed point exponent. For the fractional part, at block 710, a fractional lookup may be executed to determine a representation of the fractional part. Then, the shifted integer part and the representation of the fractional part may be multiplied to determine the exponent for the exponential function having a base that is a factor of two, at block 720.

Furthermore, at block 706, if the number format of the exponent is determined to be a floating point format, then at block 708, the process 700 may convert the floating point exponent to a fixed point format. The floating point may be split into an integer part and a fraction part. The integer part may be determined by taking the exponent portion of the floating point format and applying the exponent to a base of two. The integer part may be sent to the integer shift unit (at block 716). The mantissa of the floating point may serve as the fractional part. The fractional part may be represented according to a lookup table (at block 710). Thereafter, at block 720, the process 700 may multiply the shifted integer part and the representation of the fraction part.

In a first example, an instruction including an exponential function may be received. The exponential function may have a base B=2 and an exponent Exp=0×02 in the INT8 format. Because the exponential function has a base that is a power of two, and the exponent is an integer format that is greater than one, a left shift may be performed by two bits (value of exponent is 02). Thus, the adapted exponential function will be a base of two and an exponent=0×08 (0000010→00001000).

In a second example, an instruction including an exponential function may have a base B=2 and an exponent Exp=0×0090 (16′b0000000010_010000) in a fixed point format (U(10,6). Because the exponential function has a base that is a power of two, and the exponent has a fixed point format, the exponent may be split into an integer part (0000000010) and a fractional part (010000). For the integer part, a left shift by two bits may be performed. For the fractional part, a lookup table may be accessed to determine that the fractional part may be represented by 0.25. Then, the representations for the integer part and the fractional part may be multiplied to determine the adapted exponential function (2²×2^{0.25}=2^{2.25}).

In yet another example, an instruction including an exponential function may have a base B=2 and an exponent Exp=0×13 in the FP8 format. Because the exponential function has a base that is a power of two, and the exponent has a floating point format, the floating point value may be converted to a fixed point format. The exponent may be converted from Exp=8′b0_0010_011 (FP8 format) to a decimal number Exp=1.375×2\hat{ }2=5.5 (decimal). The decimal number may be represented as a 16-bit fixed point number (16′b0000000101_100000 U (10,6)). Then, the fixed point format may be split into an integer part (0000000101) and a fractional part (100000). The integer part may be represented with a left shift by five and the fractional part may be represented using a lookup table (e.g., 0.5). Finally, the exponential function may be represented by multiplying the integer part and the fractional part (25×2^{0.5}=2^{5.5})

Accordingly, aspects of the present disclosure may beneficially be applicable to softmax functions in attention modules, transformers, diffusion models, LLMs/LVMs, as well as generative AI models for image/video generation and editing and other ML models.

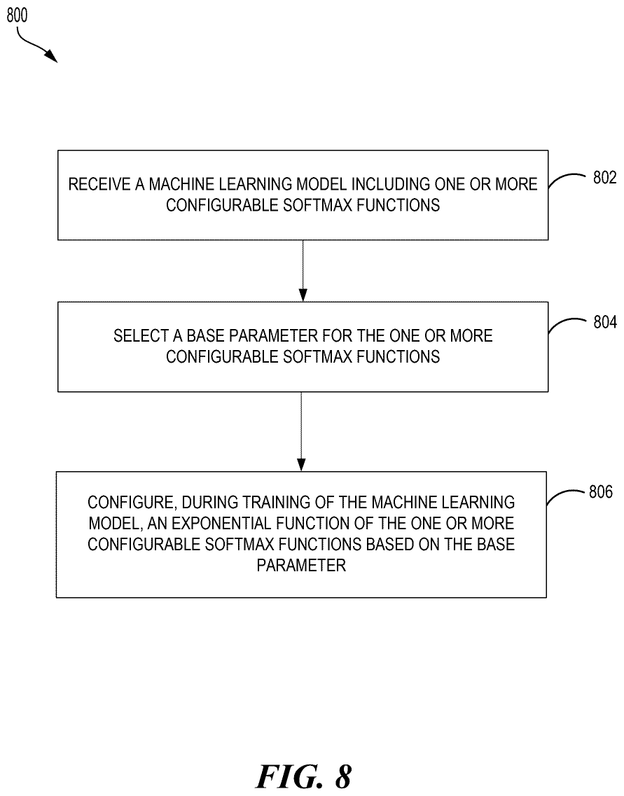

FIG. 8 is a flow diagram illustrating a processor-implemented method 800 for configuring machine learning models for implementing a flexible softmax function, in accordance with various aspects of the present disclosure. The processor-implemented method 800 may be performed by one or more processors such as the CPU (e.g., 102, 422), GPU (e.g., 104, 426), and/or other processing unit (e.g., DSP 424, NPU 428), for example.

Referring to FIG. 8, at block 802 the one or more processors receive a machine learning model including one or more configurable softmax functions. For instance, the configurable softmax functions may be implemented in machine learning (ML) models and tasks, including attention modules, transformers, diffusion models, large language models (LLMs), large vision models (LVMs), as well as generative artificial intelligence (AI) models for image/video generation and editing.

At block 804, the one or more processors select a base parameter for the one or more configurable softmax functions. As described, the flexible softmax function may offer a base hyperparameter.

At block 806, the one or more processors configure, during training of the machine learning model, an exponential function of the one or more configurable softmax functions based on the base parameter. As described for instance with reference to FIG. 7, the process 700 may determine if the exponential instruction includes a base of the power of two. If the exponential instruction does not include a base of the power of two, then the process 700 proceeds to block 718 and may employ the conventional exponential. On the other hand, if the exponential instruction has a base of the power of two, at block 706, the process 700 may determine if the number format of the exponent is a floating point. If the exponent does not have a floating point format, at block 712, the process 700 may evaluate whether the number format of the exponent is fixed point. If the number format of the exponent is not fixed point, then at block 714, the process 700 may next determine whether the number format of the exponent is an integer. If the number format of the exponent is an integer, at block 716, the process 700 may send the exponent to an integer shift unit. The integer shift unit may execute a shift operation based on the value of the integer. That is, the integer shift unit may execute a left shift operation when x>1 or a right shift operation when x<1.

### Example Aspects

Aspect 1: An apparatus, comprising: at least one memory; and at least one processor coupled to the at least one memory, the at least one processor configured to: receive a machine learning model including one or more configurable softmax functions; select a base parameter for the one or more configurable softmax functions; and configure, during training of the machine learning model, an exponential function of the one or more configurable softmax functions based on the base parameter.
Aspect 2: The apparatus of Aspect 1, wherein the at least one processor is further configured to: determine whether the base parameter has a base of two; and adapt, responsive to the base parameter being of the base of two, an exponent of the exponential function.
Aspect 3: The apparatus of Aspect 1 or 2, wherein the exponent is implemented based on a number format of the exponent.
Aspect 4: The apparatus of any preceding Aspect, wherein the at least one processor is further configured to perform a shift operation on the exponent if the number format is an integer format.
Aspect 5: The apparatus of any preceding Aspect, wherein the at least one processor is further configured to: determine if the number format is a fixed point format or a floating point format; and responsive to the number format being a floating point number, convert the exponent to the fixed point format based on a mantissa of the exponent.
Aspect 6: The apparatus of any preceding Aspect, wherein, responsive to the number format being the fixed point format, the at least one processor is further configured to: split the exponent into an integer portion and a fraction portion based on a radix point of the exponent; perform a shift operation based on the integer portion to determine a first operand; determine a second operand using a lookup table based on the fraction portion; and compute an updated exponent for the exponential function based on a product of the first operand and the second operand.
Aspect 7: The apparatus of any preceding Aspect, wherein the at least one processor is further configured to: determine whether the base parameter is of a base of two; and set, responsive to determining that the base parameter is not of the base of two, a base of the one or more configurable softmax functions to Euler's number.
Aspect 8: A processor-implemented method performed by at least one processor, the processor-implemented method comprising: receiving a machine learning model including one or more configurable softmax functions; selecting a base parameter for the one or more configurable softmax functions; and configuring, during training of the machine learning model, an exponential function of the one or more configurable softmax functions based on the base parameter.
Aspect 9: The processor-implemented method of Aspect 8, further comprising: determining whether the base parameter has a base of two; and adapting, responsive to the base parameter being of the base of two, an exponent of the exponential function.
Aspect 10: The processor-implemented method of Aspect 8 or 9, wherein the exponent is implemented based on a number format of the exponent.
Aspect 11: The processor-implemented method of any of Aspects 8-10, further comprising performing a shift operation on the exponent if the number format is an integer format.
Aspect 12: The processor-implemented method of any of Aspects 8-11, further comprising: determining if the number format is a fixed point format or a floating point format; and converting, responsive to the number format being a floating point number, the exponent to the fixed point format based on a mantissa of the exponent.
Aspect 13: The processor-implemented method of any of Aspects 8-12, further comprising, responsive to the number format being the fixed point format: splitting the exponent into an integer portion and a fraction portion based on a radix point of the exponent; performing a shift operation based on the integer portion to determine a first operand; determining a second operand using a lookup table based on the fraction portion; and computing an updated exponent for the exponential function based on a product of the first operand and the second operand.
Aspect 14: The processor-implemented method of any of Aspects 8-13, further comprising: determining whether the base parameter is of a base of two; and setting, responsive to determining that the base parameter is not of the base of two, a base of the one or more configurable softmax functions to Euler's number.
Aspect 15: An apparatus comprising: means for receiving a machine learning model including one or more configurable softmax functions; means for selecting a base parameter for the one or more configurable softmax functions; and means for configuring, during training of the machine learning model, an exponential function of the one or more configurable softmax functions based on the base parameter.
Aspect 16: The apparatus of Aspect 15, further comprising: means for determining whether the base parameter has a base of two; and means for adapting, responsive to the base parameter being of the base of two, an exponent of the exponential function.
Aspect 17: The apparatus of Aspect 15 or 16, wherein the exponent is implemented based on a number format of the exponent.
Aspect 18: The apparatus of any of Aspects 15-17, further comprising means for performing a shift operation on the exponent if the number format is an integer format.
Aspect 19: The apparatus of any of Aspects 15-18, further comprising: means for determining if the number format is a fixed point format or a floating point format; and means for converting, responsive to the number format being a floating point number, the exponent to the fixed point format based on a mantissa of the exponent.
Aspect 20: The apparatus of any of Aspects 15-19, further comprising, responsive to the number format being the fixed point format: means for splitting the exponent into an integer portion and a fraction portion based on a radix point of the exponent; means for performing a shift operation based on the integer portion to determine a first operand; means for determining a second operand using a lookup table based on the fraction portion; and means for computing an updated exponent for the exponential function based on a product of the first operand and the second operand.

In one aspect, the receiving means, selecting means, and/or configuring means may be the CPU 102/422, GPU 104/426, program memory associated with the CPU 102/422 or GPU 104/426, and/or NPU 108/428 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. An apparatus, comprising:
at least one memory; and
at least one processor coupled to the at least one memory, the at least one processor configured to:
receive a machine learning model including one or more configurable softmax functions;
select a base parameter for the one or more configurable softmax functions; and
configure, during training of the machine learning model, an exponential function of the one or more configurable softmax functions based on the base parameter.

2. The apparatus of claim 1, wherein the at least one processor is further configured to:
determine whether the base parameter has a base of two; and
adapt, responsive to the base parameter being of the base of two, an exponent of the exponential function.

3. The apparatus of claim 2, wherein the exponent is implemented based on a number format of the exponent.

4. The apparatus of claim 3, wherein the at least one processor is further configured to perform a shift operation on the exponent if the number format is an integer format.

5. The apparatus of claim 3, wherein the at least one processor is further configured to:
determine if the number format is a fixed point format or a floating point format; and
responsive to the number format being a floating point number, convert the exponent to the fixed point format based on a mantissa of the exponent.

6. The apparatus of claim 5, wherein, responsive to the number format being the fixed point format, the at least one processor is further configured to:
split the exponent into an integer portion and a fraction portion based on a radix point of the exponent;
perform a shift operation based on the integer portion to determine a first operand;
determine a second operand using a lookup table based on the fraction portion; and
compute an updated exponent for the exponential function based on a product of the first operand and the second operand.

7. The apparatus of claim 1, wherein the at least one processor is further configured to:
determine whether the base parameter is of a base of two; and
set, responsive to determining that the base parameter is not of the base of two, a base of the one or more configurable softmax functions to Euler's number.

8. A processor-implemented method performed by at least one processor, the processor-implemented method comprising:
receiving a machine learning model including one or more configurable softmax functions;
selecting a base parameter for the one or more configurable softmax functions; and
configuring, during training of the machine learning model, an exponential function of the one or more configurable softmax functions based on the base parameter.

9. The processor-implemented method of claim 8, further comprising:
determining whether the base parameter has a base of two; and
adapting, responsive to the base parameter being of the base of two, an exponent of the exponential function.

10. The processor-implemented method of claim 9, wherein the exponent is implemented based on a number format of the exponent.

11. The processor-implemented method of claim 10, further comprising performing a shift operation on the exponent if the number format is an integer format.

12. The processor-implemented method of claim 10, further comprising:
determining if the number format is a fixed point format or a floating point format; and
converting, responsive to the number format being a floating point number, the exponent to the fixed point format based on a mantissa of the exponent.

13. The processor-implemented method of claim 12, further comprising, responsive to the number format being the fixed point format:
splitting the exponent into an integer portion and a fraction portion based on a radix point of the exponent;
performing a shift operation based on the integer portion to determine a first operand;
determining a second operand using a lookup table based on the fraction portion; and
computing an updated exponent for the exponential function based on a product of the first operand and the second operand.

14. The processor-implemented method of claim 8, further comprising:
determining whether the base parameter is of a base of two; and
setting, responsive to determining that the base parameter is not of the base of two, a base of the one or more configurable softmax functions to Euler's number.

15. An apparatus comprising:
means for receiving a machine learning model including one or more configurable softmax functions;
means for selecting a base parameter for the one or more configurable softmax functions; and
means for configuring, during training of the machine learning model, an exponential function of the one or more configurable softmax functions based on the base parameter.

16. The apparatus of claim 15, further comprising:
means for determining whether the base parameter has a base of two; and
means for adapting, responsive to the base parameter being of the base of two, an exponent of the exponential function.

17. The apparatus of claim 16, wherein the exponent is implemented based on a number format of the exponent.

18. The apparatus of claim 17, further comprising means for performing a shift operation on the exponent if the number format is an integer format.

19. The apparatus of claim 17, further comprising:
means for determining if the number format is a fixed point format or a floating point format; and
means for converting, responsive to the number format being a floating point number, the exponent to the fixed point format based on a mantissa of the exponent.

20. The apparatus of claim 19, further comprising, responsive to the number format being the fixed point format:
means for splitting the exponent into an integer portion and a fraction portion based on a radix point of the exponent;
means for performing a shift operation based on the integer portion to determine a first operand;
means for determining a second operand using a lookup table based on the fraction portion; and
means for computing an updated exponent for the exponential function based on a product of the first operand and the second operand.
